(19) United States
(12) Patent Application Publication
(10) Pub. No.: US 2008/0118178 A1
(43) Pub. Date: May 22, 2008

(54) Display systems and methods for eliminating mullions

(76) Inventors: Olan C. Way, Corvallis, OR (US); Aloke Gupta, Corvallis, OR (US); David L. Bateham, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/602,615

(22) Filed: Nov. 20, 2006

(51) Int. Cl. G06K 9/40; G09G 5/00

(52) U.S. Cl. 382/275; 345/1.3

(57) ABSTRACT

A display system having a number of individual display devices that cooperate to display a large-scale image includes a number of display devices configured to cooperate to produce the large-scale image by each displaying a portion of the large-scale image; at least one camera for imaging the large-scale image displayed by the display devices and an image server receiving output from the camera. The image server is configured to determine whether any mullions exist in the large-scale image using the output from the camera and to modify image signals for the display devices to eliminate any mullions. A method of displaying a large-scale image includes imaging the large-scale image as produced on a display system comprising a plurality of individual display devices that cooperate to display the large-scale image by each displaying a portion of the large-scale image; determine whether any mullions exist in the large-scale image using the imaging of the large-scale image; and modifying image signals for the display devices to eliminate any detected mullions.

### BACKGROUND

In a variety of applications, it is desired to provide a very large display without sacrificing image quality. For example, a large video display can be useful and desired at sporting events, in conference rooms, in educational facilities, at trade shows, in retail outlets, in airports, along streets and highways and in many other situations.

A large video display can be created with a projector that projects a large video or still image onto a screen or other display surface, as in a movie theatre. However, such displays can be difficult to see in bright ambient light and usually function best in lower lighting levels. Such lower lighting levels may not be suitable or available for all desired applications.

Another method of providing a large video display has been to place a number of smaller display devices in a grid or array so that each individual display device shows a part of a larger image being displayed. The individual display devices may be, for example, cathode ray tube monitors, liquid crystal display device or other display devices. This approach of combining a number of smaller display devices to produce a larger display is sometimes referred to as a “video wall.”

### SUMMARY

A display system having a number of individual display devices that cooperate to display a large-scale image includes a number of display devices configured to cooperate to produce the large-scale image by each displaying a portion of the large-scale image; at least one camera for imaging the large-scale image displayed by the display devices and an image server receiving output from the camera. The image server is configured to determine whether any mullions exist in the large-scale image using the output from the camera and to modify image signals for the display devices to eliminate any mullions. A method of displaying a large-scale image includes imaging the large-scale image as produced on a display system comprising a plurality of individual display devices that cooperate to display the large-scale image by each displaying a portion of the large-scale image; determining whether any mullions exist in the large-scale image using the imaging of the large-scale image; and modifying image signals for the display devices to eliminate any detected mullions.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 illustrates an exemplary large-scale display system according to principles described herein.

FIG. 2 illustrates an exemplary projection system used in the display system of FIG. 1 according to principles described herein.

FIG. 3 illustrates an exemplary diagram of an image processing system according to principles described herein.

FIG. 4 is a flowchart illustrating an exemplary method of operating a large-scale display system according to principles described herein.

Throughout the drawings, identical reference numbers designate similar, but not necessarily identical, elements.

### DETAILED DESCRIPTION

In traditional usage, a mullion is a framing element which divides adjacent window, door, or glass units. In the context of a video wall, the term “mullion” refers to the junctions or borders between adjacent display devices in a video wall at which the large image being displayed by the various display devices of the video wall is typically interrupted or distorted. The effect may be compared to viewing a scene through a window composed of an array of smaller panes of glass that are divided by vertical mullions and horizontal transoms which partially obscure the scene beyond the window.

The present specification describes methods and system for a video wall or large scale display in which a number of different projectors or other display devices that are arranged in an array each display a portion of a larger image while eliminating mullions or other visual effects that might occur along borders between the displays of adjacent display devices. As a result, the larger image being displayed appears seamless without visual evidence of the individual displays that make up the larger image. The resulting image consequently provides a large-scale display without sacrificing image quality.

As used herein and in the appended claims, an “image” or “projected image” will be broadly understood to include a still image, a series of still images, full-motion video, motion pictures, or any combination thereof. There is no limitation on the “image” being displayed by the exemplary systems described herein.

Also, as used herein and in the appended claims, the term “large-scale image” or “large-scale display” will refer to an image or a display that comprises the output of more than one individual display device. Typically, the plurality of individual display devices will each be driven with a portion or subset of image data from a single image signal received by the display system.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

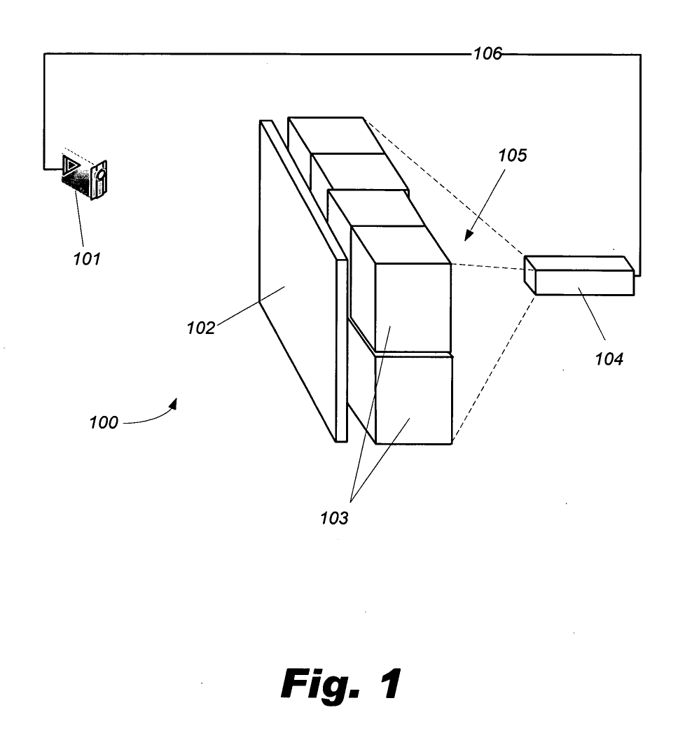

FIG. 1 illustrates an exemplary large-scale display system according to principles described herein. As shown in FIG. 1, a projection system (104), which will be described in greater detail below, includes an array of projectors or projection units. For example, the array of projectors may be a four-by-two array or projectors with two rows of four projectors each that are stacked vertically. However, any configuration of any number of projectors or projection units may be used as best suits a particular application. For example,

As will be appreciated by those skilled in the art, each projector of the projection system (104) will receive an image signal carrying image data representing an image that is to be projected. The image signal received by any single projector in the projector system (104) will be a portion, e.g., ⅛, of a larger image that is to be displayed.

In some embodiments, the projector will use the data from the incoming image signal to drive a spatial light modulator, for example, a liquid crystal display device or a micro-mirror display device. A beam of light is then reflected from, or transmitted through, the spatial light modulator such that the light beam is modulated with the image from the image signal that is driving the spatial light modulator. The modulated light beam can then be projected through optics of the projector to a display surface where the image from the spatial light modulator is then visible to a viewer.

In a rear-projection system, the modulated light beam is directed to the rear surface of a translucent screen. The viewer, located on the opposite or front side of the screen, is then able to see the image that transmits through the screen to appear on the side of the screen facing the viewer.

Each of the projectors of the projection system (104) is aligned with a display cube (103). The display cubes (103) are stacked in an array that corresponds to the array of projectors in the projection system (104). Each projector in the projection system (104) of FIG. 1 projects a portion of the larger image that is to be displayed to a corresponding display cube (104).

Each display cube (103) receives an image projected by a projector of the projection system (104) and passes the modulated image light beam therethrough to a front of the cube (103). The sides of the display cubes (103) help prevent light from one projected image from affecting the adjacent light beams and their associated images.

In some systems, each of the display cubes (103) may include a rear-projection screen at the front of the cube (103) on which the image from the corresponding projector of the projection system (104) is displayed. However, in such a configuration, mullions will be apparent along the edges of adjacent display cubes (103). The viewer will clearly see a video wall in which individual display device, e.g., display cubes (103), and the partitioning of the larger image are visually apparent.

To address these issues, the exemplary system of FIG. 1 may not include individual rear projection screens at the front of each display cube (103). Rather, a single rear projection screen (102) is placed over the entire array of display cubes (103). Consequently, there is no physical partitioning apparent between the screens of adjacent display cubes (103), which could contribute to mullions, or the perception of mullions, in the large-scale image being displayed.

In addition to removing physical partitioning between adjacent display portions of the large-scale image, the system of FIG. 1 next removes any visual evidence or visual artifacts that might appear between at the intersection of adjacent display portions of the large scale image, e.g., along lines corresponding to the lines between the adjacent display cubes (103) behind the screen (102).

With the single rear-projection screen (102) in place, there will be seams of overlapping pixels between adjacent displays that can be addressed by the projector of the projection system (104) that is producing either display. Consequently, the image signal being provided to the respective projectors of the projection system (104) can be modified with regard to those pixels in the overlapping seam between displays to blend the to adjacent displays into a uniform picture with no mullion. This is done for each line between two adjacent displays to remove all mullions from the large-scale display.

To accomplish this, a camera (101) is provided on the front side of the rear projection display screen (102). The camera (101) images the integrated display of the various projectors of the projection system (104) as it appears to a viewer on the front side of the rear projection screen (102).

The image from the camera (101) is transmitted to the projection system (104). This transmission of the camera image to the projection system (104) can be wired or wireless as best suits a particular application. In FIG. 1, a data line (106) is illustrated for transmitting the image taken by the camera (101) to the projection system (104).

As will be described in more detail below, an algorithm of the projection system (104) will use the image from the camera (101) to determine whether any mullions or visual effects are apparent in the image displayed on the screen (102) as a result of dividing that image being displayed into separate portions that are projected by individual projectors. More specifically, the algorithm will use the image from the camera (101) to detect misalignment, overlap and any non-uniformity between adjacent displays within the large-scale image being shown. Where any such mullions appear, the algorithm of the projection system (104) will modify the image signal being sent to the array of projectors so as to blend the transitions between the display from any one projector and from any other projector to remove the mullion or visual effect that indicates that the image being display has been partitioned during the display process.

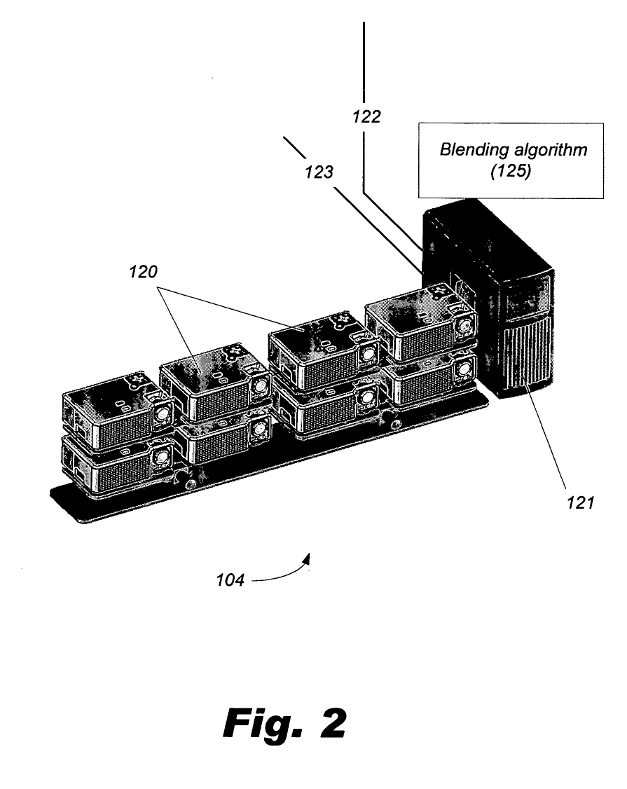

FIG. 2 illustrates an exemplary projection system (104) that can be used in the display system (100) of FIG. 1 according to principles described herein. As shown in FIG. 2, an array of individual projectors (120) is provided. As in the example above, the projectors (120) are arranged as two vertically stacked rows of four projectors each.

Each of the projectors (120) in the array is receives an image signal from an image server (121). As described above, the image signal distributed to any one of the projectors (120) is a portion of a larger image to be displayed.

The image server (121) receives an incoming image signal (122) that represents the image to be displayed. As noted above, an “image” may be a still image, a series of still images, motion picture video or any combination thereof.

The image server (121) also receives a feed (123) from the camera (101, FIG. 1) that is imaging the display being produced by the combined and simultaneous use of the array of projectors (120). As noted above, the image feed (123) from the camera (101, FIG. 1) will be processed by a blending algorithm (125) being executed, for example, by the image server (121).

In various embodiments of the principles described herein the image server (121) may be a single server device or may include a number of individual devices that may or may not be physically separate. For example, in some embodiments, the image server (121) may include a camera interface, a calibration device and/or an Image pipeline, each of which is a physically separate device. Thus, as used herein and in the appended claims, the term “image server” refers to any device or number of devices that collectively function according to the principles described herein, e.g., receive image data, distribute that image data to an array of display devices in a video wall and modify the image data being sent to those display devices based on a camera feed to eliminate mullions in the video wall display.

Referring again to FIG. 2, the blending algorithm (125) will use the image feed (123) from the camera (101, FIG. 1) to determine whether any mullions or visual effects are apparent in the image displayed on the screen (102, FIG. 2) as a result of dividing that image being displayed into separate portions that are projected by individual projectors (120). Where any such mullions appear, the blending algorithm (125) of the image server (121) will modify the image signal or signals being sent to the array of projectors (120) so as to blend the transitions between the display from adjacent projectors (120) to remove the mullion or visual effect that indicates that the image being displayed is partitioned. This blending may include any of automatic edge blending, luminance matching, color matching and/or black-level matching to produce a large-scale uniform display.

As will be appreciated by those skilled in the art with the benefit of this disclosure, a wide variety of techniques can be used to implement the blending algorithm (125) to both recognize mullions that need correction and to appropriately blend adjacent displays to eliminate the effect of each such mullion. Any of these techniques may be used within the context of the exemplary system being described herein.

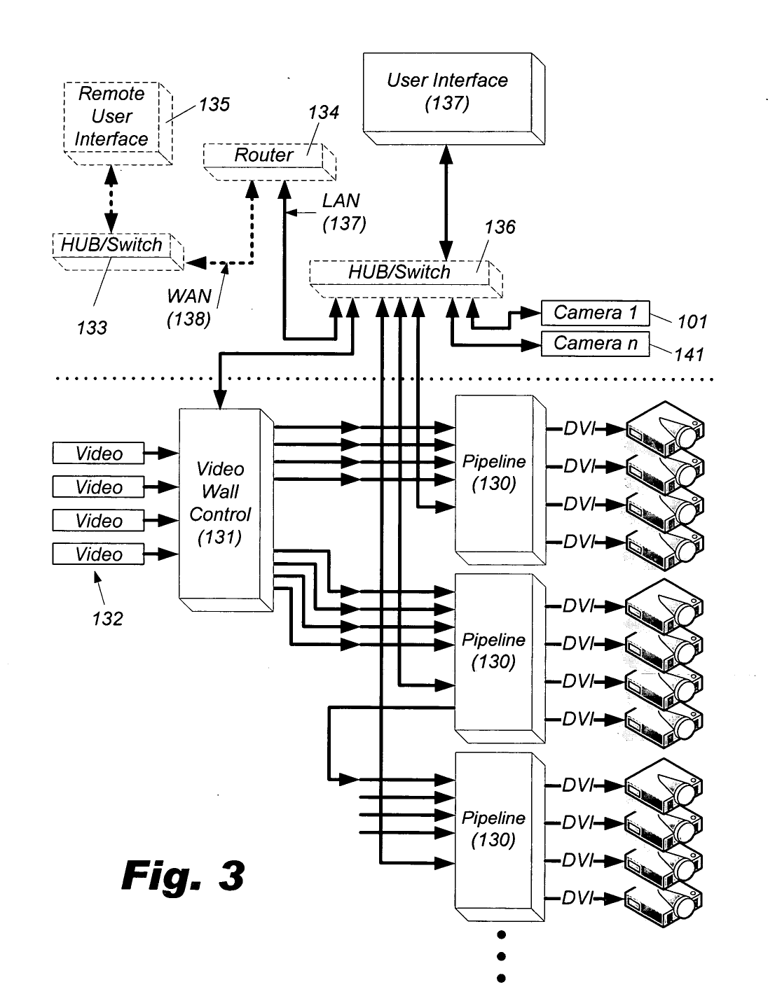

FIG. 3 illustrates an exemplary diagram of an image processing system according to principles described herein. As indicated above, any number of projectors or other display devices may be combined according to the principled disclosed herein to produce the desired large-scale display with good image quality and ambient light rejection. By way of example, a projection system (104) is illustrated and described with reference to FIG. 2 including eight projectors in a four-by-two configuration and driven by an image server.

In other embodiments, there may be multiple image servers each controlling a sub-set of the total number of projectors or other display devices that are, together, generating the large-scale display. An example of one such embodiment is illustrated in FIG. 3.

As shown in FIG. 3, a number of projectors (120) are provided. As above, any number of projectors (120) may be used, with each projecting a portion of the overall image being displayed. As shown in FIG. 3, the projectors (120) are grouped, with each group being in communication with and controlled by a separate video pipeline (130). A video wall control (131) receives any number of video inputs (132) and distributed video signals and control signals to the various pipelines (130), which, in turn, drive the array of projectors (120).

As explained above, a camera (101) images the display resulting from the output of the projectors (120). The feed from the camera (101) is returned through a hub (136) and can be provided from the hub (136) to either or both of the video wall control (131) or the individual pipelines (130). Consequently, the blending algorithm that uses the imaging from the camera (101) can be implemented in either the view wall control (131) or the individual pipelines (130).

As shown in FIG. 3, a second camera (141) or any number of cameras may be used in various embodiments to image the display as produced by the array of projectors (120). The video feed from any number of cameras (101, 141) can be used by the blending algorithms described herein to eliminate mullions in the large-scale display created by the combined displays of the array of projectors (120).

A user interface (137) is also provided to allow a user to control the system. The user interface (137) may be connected through the hub (136) to the video wall control (131), the pipelines (130) and/or the cameras (101, 141). Consequently, the user interface (137) can be used to optimize the large-scale display being produced. For example, the user interface (137) can be used to control which video input (132) or inputs are used to drive the projectors (120). Different video inputs (132) can be arranged side by side, picture-in-picture, tiled or in any other configuration as desired in the final large-scale display. The user interface (137) can also be used to control or modify any aspect of the system, for example, the blending algorithm used or the controls of individual projectors (120) such as focus, tint, brightness, etc.

In some embodiments, a remote user interface (135) may also be provided so that a user can operate the system from another location. The remote user interface (135) may have all the capabilities of the local user interface (137) as described above.

The remote user interface (135) may communicate with the system through a Local Area Network (LAN) (137), such as through a router (134) connected to the same network (137) as the hub (136). Additionally or alternatively, a remote user interface (135) may be part of a different network, such as a network including a hub (133) that is connected to a Wide Area Network (WAN) (138) that also includes a connection to the Local Area Network (137). The WAN (138) may, in some examples, include a global network such as the Internet.

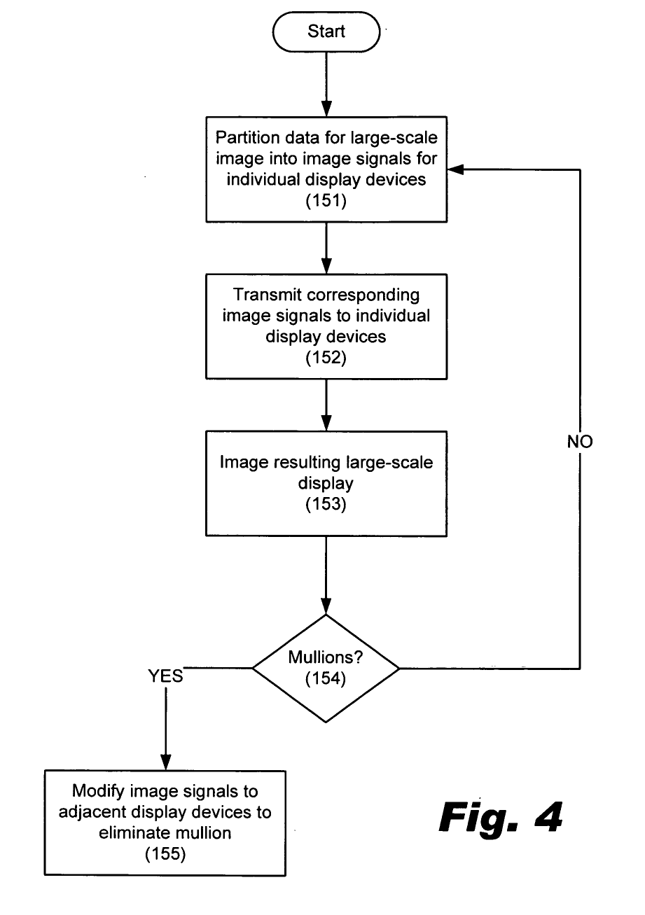

FIG. 4 is a flowchart illustrated on exemplary method of operating a large-scale display system according to principles described herein. As shown in FIG. 4, the image data for the large-scale image to be displayed is partitioned to produce image signals for each of a number of individual display devices (step 151). The image signal for each such display device contains or represents a portion or block of the large-scale image to be displayed.

The separate image signals for the individual display devices are then transmitted to the corresponding individual display devices (step 152). Each individual display device then displays an image based on the image signal received. In the examples above, the display devices are projectors that cooperate to project a number of individual images that, in combination, provide a much larger image.

This resulting large-scale display is then imaged (step 153) using, for example, one or more cameras trained on the large-scale display. The image from the camera or cameras is used to determine whether any mullions appear in the mosaic of the overall image. In this sense, a mullion is any aspect of the large-scale image that visually indicates that the large-scale image is composed of a number of smaller images produced by different display devices. Consequently, mullions are usually linear and coincide with the borders of the smaller, individual displays.

If any mullions are detected (determination 154), the image signals being sent to the corresponding display devices are modified to blend the image of one such display device into the image of another (step 155). This blending may include any of automatic edge blending, luminance matching, color matching and/or black-level matching to produce a large-scale uniform display. The blending typically occurs in a seam of pixels in the large-scale image that are addressable by both of the adjacent individual display devices.

This process can be repeated periodically or continually to eliminate the existence of mullions in the resulting large-scale display.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A display system comprising a plurality of individual display devices that cooperate to display a large-scale image, said system comprising:
said plurality of display devices configured to cooperate to produce said large-scale image by each displaying a portion of said large-scale image;
at least one camera for imaging said large-scale image displayed by said display devices; and
an image server receiving output from said camera;
wherein said image server is configured to determine whether any mullions exist in said large-scale image using said output from said camera and to modify image signals for said display devices to eliminate any mullions.

2. The display system of claim 1, further comprising a single screen covering said display devices and configured to display an image from each of said display devices as part of said large-scale image.

3. The display system of claim 2, wherein said single screen is a rear projection screen and said display devices comprise projectors.

4. The display system of claim 1, wherein said display devices comprise projectors.

5. The display system of claim 1, wherein said at least one camera comprises a plurality of cameras.

6. The display system of claim 1, further comprising a blending algorithm configured for execution by said image server to modify image signals for said display devices to eliminate mullions.

7. The display system of claim 6, wherein said blending algorithm modifies said image signals with respect to a seam of pixels in said large-scale image that are addressable by either of two adjacent said display devices.

8. The display system of claim 6, wherein said blending algorithm performs edge-blending, luminance matching, color matching and/or black-level matching to eliminate mullions in said large-scale image.

9. The display system of claim 1, further comprising a user interface for controlling said system.

10. The display system of claim 9, wherein said user interface is a remote user interface configured to communicate with said system through a network.

11. A method of displaying a large-scale image, said method comprising;
imaging said large-scale image as produced on a display system comprising a plurality of individual display devices that cooperate to display said large-scale image by each displaying a portion of said large-scale image;
determine whether any mullions exist in said large-scale image using said imaging of said large-scale image; and
modifying image signals for said display devices to eliminate any detected mullions.

12. The method of claim 11, covering said display devices with a screen configured to display an image from each of said display devices as part of said large-scale image.

13. The method of claim 12, wherein said screen is a rear projection screen and said display devices comprise projectors.

14. The method of claim 11, wherein said display devices comprise projectors.

15. The method of claim 11, wherein said modifying further comprises executing a blending algorithm configured to modify said image signals for said display devices based on said imaging of said large-scale image to eliminate mullions in said large-scale image.

16. The method of claim 15, wherein said blending algorithm modifies said image signals with respect to a seam of pixels in said large-scale image that are addressable by either of two adjacent said display devices.

17. The method of claim 15, further comprising, with said blending algorithm, performing edge blending, luminance matching, color matching and/or black-level matching to eliminate mullions in said large-scale image.

18. A display system for displaying a large-scale image, said system comprising;
means for imaging said large-scale image as produced on a display system comprising a plurality of individual display devices that cooperate to display said large-scale image by each displaying a portion of said large-scale image;
means for determining whether any mullions exist in said large-scale image using said means for imaging of said large-scale image; and
means for modifying image signals for said display devices to eliminate any detected mullions.

19. The system of claim 18, further comprising a screen covering said display devices and configured to display an image from each of said display devices as part of said large-scale image.

20. The system of claim 19, wherein said screen is a rear projection screen and said display devices comprise projectors.

21. The system of claim 18, wherein said display devices comprise projectors.
